(19) United States
(12) Patent Application Publication
(10) Pub. No.: US 2019/0363390 A1
(43) Pub. Date: Nov. 28, 2019

(54) BATTERY CELL STRUCTURE IMPROVEMENT

(71) Applicant: WEI HAO LIAO, Taipei (TW)

(72) Inventor: WEI HAO LIAO, Taipei (TW)

(21) Appl. No.: 15/985,717

(22) Filed: May 22, 2018

(51) Int. Cl. H01M 10/04; H01M 2/26

(52) U.S. Cl. CPC H01M 10/045; H01M 10/0418; H01M 2/263

(57) ABSTRACT

An improved battery cell structure comprises an inner electrode plate having an inner electrode ear, an outer electrode plate having an outer electrode ear, and a partition plate superposed between the inner electrode plate and the outer electrode plate; the unique battery cell structure design rests on the external shape that can be regular or irregular, so that the inner electrode ear and the outer electrode ear can be arbitrarily configured according to the shape to fully utilize the space and easily install or accommodate in the space confined by the carrier. The stacked battery structure composed of plural sets of battery cell can effectively improve the battery efficiency.

### BACKGROUND OF INVENTION

### 1. Field of the Invention

The present invention relates generally to a battery, and more particularly to a stacked battery structure technology.

### 2. Description of Related Art

As the situation of air pollution worsens, under the trend of improving environmental protection, devices for reducing carbon emissions and the related applications can contribute to the improvement of air and environmental quality. However, currently advocated electric vehicles mainly rely on rechargeable batteries carried by vehicles. When applied to the drive of automobiles and motorcycles, in terms of charging characteristics and their size, the batteries in battery charging power, endurance, accommodation space, weight, life and safety have encountered some bottlenecks.

In today's mobile communication portable devices, in addition to the demand for lighter, thinner, shorter, and smaller miniaturization, there has been an increase in styling and beautification. Under this trend of development, the physical characteristics of the rechargeable battery, as described above, have been lowered and are subject to further restriction. In order to provide a high power storage capacity structure, a long strip-shaped inner electrode plate and an outer electrode plate separated by a partition plate are generally wound so that the conductive path will be increased as the power storage capacity increases, and the internal resistance of the battery will also increase, which is easy to generate heat in a narrow space, making the battery efficiency unable to be fully exerted. This situation has a hidden crisis that cannot be ignored, either for the user or for the device.

In view of this, the problems encountered in the electric drive applied to the electric vehicles and the mobile communication portable devices are actually dependent on the industry to seek a better solution to the problem.

### SUMMARY OF THE INVENTION

In view of this, the present inventor provides a battery cell structure of a stacked battery. With a unique battery cell structure design, the battery structure is composed of a plurality of sets of battery cell structure, which can be in a regular or irregular external shape to be installed or accommodated in a space confined by a carrier, and is able to effectively improve the battery efficiency.

In order to achieve the above object, the present invention provides an improved battery cell structure, wherein the battery cell comprises an inner electrode plate having an inner electrode ear, an outer electrode plate having an outer electrode ear, and a partition plate superposed between the inner electrode plate and the outer electrode plate; the inner electrode plate, the outer electrode plate, and the partition plate can both be made in regular or irregular geometry to constitute an external shape, and all have an inner hole; the electrode characteristics of the inner electrode plate and the outer electrode plate are different from each other; the inner electrode ear is disposed on the periphery of the inner hole of the inner electrode plate, and the outer electrode ear is disposed on the outer periphery of the outer electrode plate.

The external shapes of the inner electrode plate, the outer electrode plate and the partition plate may be circular, rectangular, arc-shaped, polygonal and irregular geometric shape formed by any combination of the foregoing.

The above inner electrode ear and the outer electrode ear are not overlapped and staggered to be arranged on both sides of the partition plate, and the outer electrode ear can be wholly or partially disposed on the outer periphery of the outer electrode plate.

Both sides of the above partition plate are respectively configured with two electrolyte layers as an insulating material layer for isolating the inner electrode plate and the outer electrode plate.

The above battery cell may be attached to or accommodated in a carrier, and the external shape of the battery cell coincides with the shape of the carrier.

The above carrier is a circuit board type. The battery cell is attached to the circuit board. The circuit board has at least one set of two electrical connectors, which are set to be positive and negative electrodes for electrically conducting the inner electrode ear and the outer electrode ear, respectively, for supplying positive and negative power to the circuit board.

The above carrier is a shell type. The battery cell is contained in the shell. The shell has at least one set of two electrical connectors, which are set to be positive and negative electrodes to be electrically conduct the inner electrode ear and the outer electrode ear, respectively, for supplying positive and negative powers to the two electrical connectors.

The present invention is a stacked battery structure, comprising a plurality of sets of battery cell structure, and an isolation layer is interposed between the plural sets of battery cell structure.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of the battery cell structure of the present invention.

FIG. 2 is an exploded view of the stacked battery structure of the present invention.

FIG. 3 is a partial enlarged sectional view of the battery cell structure of the present invention.

FIG. 4 is a partial enlarged sectional view of the stacked battery structure of the present invention.

FIG. 5 is a schematic diagram of the other embodiment of the present invention.

FIG. 6 is a schematic diagram of another embodiment of the present invention.

### DETAILED DESCRIPTION OF THE INVENTION

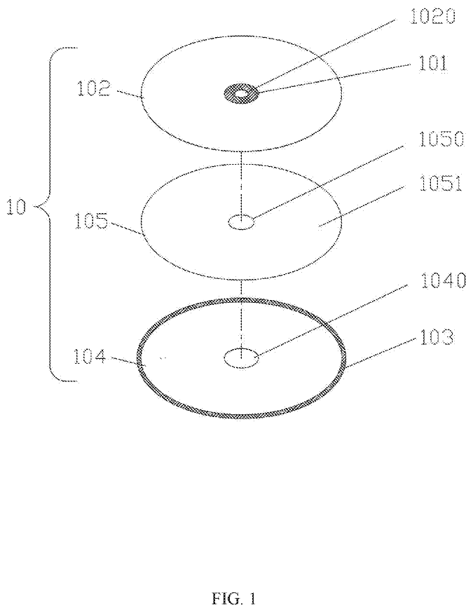

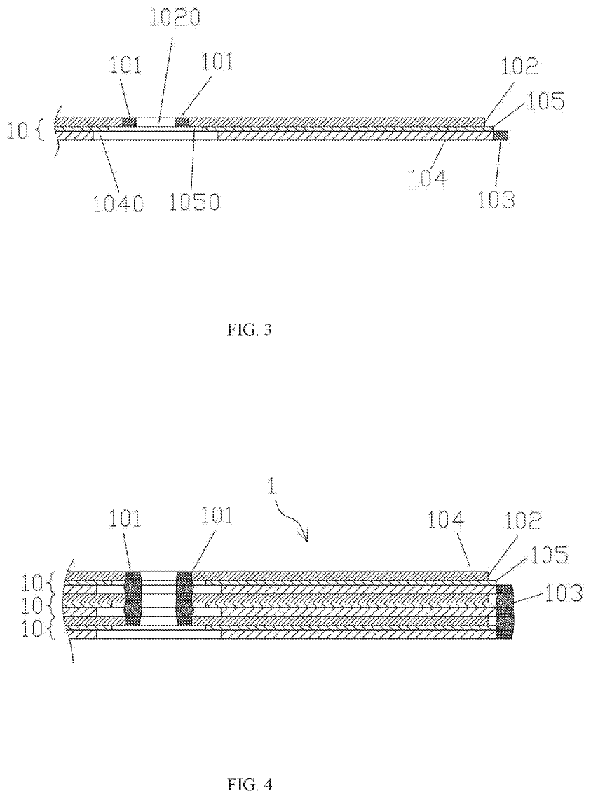

Referring to FIGS. 1 to 4, which are the schematic diagrams of the battery cell structure and the battery cell structure of the stacked battery. The battery cell 10 comprises an inner electrode plate 102 having an inner electrode ear 101, an outer electrode plate 104 having an outer electrode ear 103, and a partition plate 105 superposed between the inner electrode plate 102 and the outer electrode plate 104. The inner electrode ear 101 is disposed on the periphery of the inner hole 1020 of the inner electrode plate 102, and the outer electrode ear 103 is disposed on the outer periphery of the outer electrode plate 104. The inner electrode ear 101 and the outer electrode ear 103 are not overlapped and staggered to be arranged on both sides of the partition plate 105. The outer electrode ear 103 can be wholly or partially disposed on the outer periphery of the outer electrode plate 104.

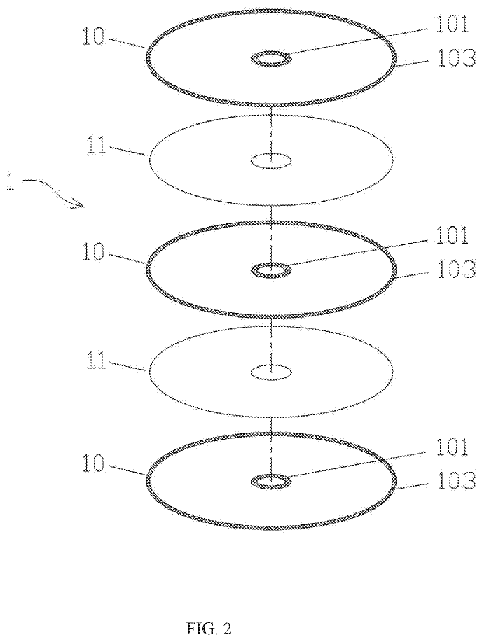

Referring to FIG. 2, which is a stacked battery structure of the present invention. The structure of battery 1 comprises a plurality of sets of battery cell 10 structure, and an isolation layer 11 is interposed between the plural sets of battery cell 10 structure.

The inner electrode plate 102, the outer electrode plate 104, the partition plate 105 and the isolation layer 11 of this embodiment are all disks with inner holes in the center. The inner hole can be arbitrarily arranged in its inner center or other positions, wherein the hole diameter of the inner hole 1050 of the partition plate 105 is larger than the hole diameter of the inner hole 1020 of the inner electrode plate 102, and is smaller than the hole diameter of the inner hole 1040 of the outer electrode plate 104. The diameter of the partition plate 105 is greater than the diameter of the inner electrode plate 102, and smaller than the diameter of the outer electrode plate 104. Two electrolyte layers are respectively disposed on two sides of the partition plate 105 as the insulating material layer for isolating the inner electrode plate 102 and the outer electrode plate 104, and may be selected from one of the insulating material layers such as Self-Terminated Oligomers with hyper Branched Architecture (STOBA), Polyimide Film (PIF), Polyethylene Terephthalate (PET) and Polyethylene (PE), etc., and two electrolyte layers 1051 are respectively disposed on two sides of the insulating material layer.

In this invention, the electrode characteristics of the inner electrode plate 102 and the outer electrode plate 104 are different from each other. If the inner electrode plate 102 is set as a positive electrode, a positive electrode metal layer of aluminum and a positive electrode material layer of aluminum cobalt oxide may be used. Then, the outer electrode plate 104 needs to be set as negative electrode, and a negative electrode metal layer of copper and negative electrode material layer of graphite may be used, and vice versa.

The battery cell 10 of the present invention may be attached to or accommodated in a carrier, and the outer shape of the battery cell 10 coincides with the shape of the carrier and is correspondingly attached to or accommodated in the shape confined by the carrier. The external shape of the inner electrode plate 102, the outer electrode plate 104, the partition plate 105 and the isolation layer 11 may be circular, rectangular, arc-shaped, polygonal and irregular geometric shape formed by any combination of the foregoing, so that it can coincide with the attached or accommodated space confined by the carrier, and the battery structure so constructed can easily conform to the external shape of the battery 1 under various confined shapes of space and smoothly provide power. After the plural sets of battery cells 10 of the battery 1 are stacked according to the required storage capacity, the inner electrode ear 101 and the outer electrode ear 103 of each battery cell 10 can be connected by laser welding to form the positive electrode and the negative electrode of a battery, wherein the electrode characteristics of the inner electrode ear 101 and the inner electrode plate 102 of each set of battery cell 10 are the same, and the electrode characteristics of the outer electrode ear 103 and the outer electrode plate 104 are the same. The inner electrode ears 101 of each set of battery cell 10 are respectively connected and electrically conductive to act as a positive electrode or a negative electrode of the battery. The outer electrode ears 103 of each set of battery cell 10 are respectively connected and electrically conductive to act as a positive electrode or a negative electrode of the battery. This approach can make conductive path of each set of battery cell 10 approximately the same to reduce the internal resistance of battery and improve the energy efficiency of the battery.

In the foregoing embodiment, the inner electrode plate 102, the outer electrode plate 104, the partition plate 105 and the isolation layer 11 are all in the form of a disk. It should be known to those skilled in the art that for such a stacked battery 1 structure, the shapes of the inner electrode plate 102, the outer electrode plate 104, the partition 105 and the isolation layer 11, etc., can be configured for the electrode characteristic in accordance with the positional relationship of positive and negative electrical connections, and the staggered inner electrode ear and the outer electrode ear can be appropriately arranged according to the difference in shape. The shape of the following embodiments may be various shapes such as a trapezoidal shape or a closed two concentric circular arcs, as long as the positions of staggered inner electrode ear and the outer electrode ear can be appropriately selected. In addition, the number of required battery cells may also be selected according to the size of the power storage capacity. The structure of battery 1 composed of plural battery cells 10 is also very flexible in series or parallel operation.

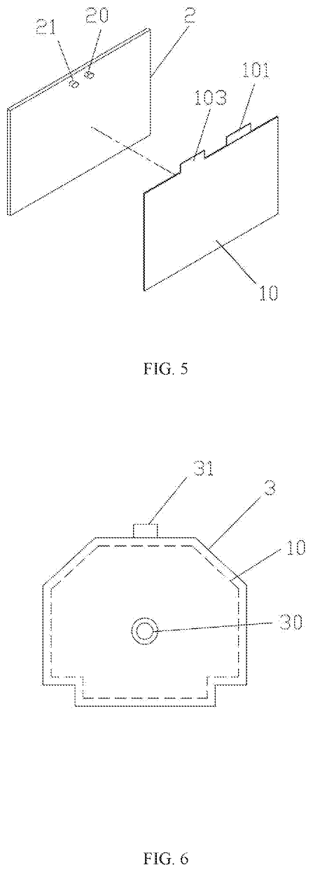

Referring to FIG. 5, which is the other preferred embodiment of the present invention. The above-mentioned carrier is a circuit board type. The battery cell 10 is attached to the circuit board 2, which has at least one set of two electrical connectors 20, 21, which are set to be positive and negative electrodes for electrically conducting the inner electrode ear 101 and the outer electrode ear 103, respectively, and disposed to the outer periphery of the same side of the battery cell 10. In addition, the inner electrode ear 101 and the outer electrode ear 103 can also be configured, as described in the previous embodiment, to the periphery of inner hole and outer periphery to supply positive and negative powers to the circuit board.

Referring to FIG. 6, which is another preferred embodiment of the present invention. The carrier is a shell type. The carrier is a shell type. The shell 3 has an irregular shape, and the battery cell 10 is accommodated in the shell 3. The shell 3 has at least one set of two electrical connectors 30, 31, which are set to be positive and negative electrodes for electrically conducting the inner electrode ear 101 and the outer electrode ear 103, respectively, to supply positive and negative powers to the two electrical connectors. With the consideration of the power storage capacity, a battery composed of a plurality of stacked battery cell structures can provide greater power storage capacity.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims. BATTERY SEPARATOR MEMBRANE DRYING DEVICE AND METHOD

1. An improved battery cell structure is provided, wherein the battery cell comprises an inner electrode plate having an inner electrode ear, an outer electrode plate having an outer electrode ear, and a partition plate superposed between the inner electrode plate and the outer electrode plate; the inner electrode plate, the outer electrode plate, and the partition plate can both be made in regular or irregular geometry to constitute an external shape, and all have an inner hole; the electrode characteristics of the inner electrode plate and the outer electrode plate are different from each other, the inner electrode ear is disposed on the periphery of the inner hole of the inner electrode plate, and the outer electrode ear is disposed on the outer periphery of the outer electrode plate.

2. The improved structure defined in claim 1, wherein external shapes of the inner electrode plate, the outer electrode plate and the partition plate may be circular, rectangular, arc-shaped, polygonal and irregular geometric shape formed by any combination of the foregoing.

3. The improved structure defined in claim 1, wherein the inner electrode ear and the outer electrode ear are not overlapped and staggered to be arranged on both sides of the partition plate, and the outer electrode ear can be wholly or partially disposed on the outer periphery of the outer electrode plate.

4. The improved structure defined in claim 1, wherein both sides of the above partition plate are respectively configured with two electrolyte layers as an insulating material layer for isolating the inner electrode plate and the outer electrode plate.

5. The improved structure defined in claim 1, wherein the battery cell may be attached to or accommodated in a carrier, and the external shape of the battery cell coincides with the shape of the carrier.

6. The improved structure defined in claim 5, wherein the carrier is a circuit board type. The battery cell is attached to the circuit board. The circuit board has at least one set of two electrical connectors, which are set to be positive and negative electrodes for electrically conducting the inner electrode ear and the outer electrode ear, respectively, for supplying positive and negative power to the circuit board.

7. The improved structure defined in claim 5, wherein the carrier is a shell type. The battery cell is contained in the shell. The shell has at least one set of two electrical connectors, which are set to be positive and negative electrodes to be electrically conduct the inner electrode ear and the outer electrode ear, respectively, for supplying positive and negative powers to the two electrical connectors.

8. The improved structure defined in claim 1, and an isolation layer is interposed between the plural sets of battery cell structure.
